(19) United States
(12) Patent Application Publication
(10) Pub. No.: US 2013/0233397 A1
(43) Pub. Date: Sep. 12, 2013

(54) Regurgitant Control Directional Flow Valve for Simulating Cardiovascular Hemodynamics

(71) Applicants: Benjamin McCLOSKEY, Evergreen, CO (US); Craig WEINBERG, Denver, CO (US)

(72) Inventors: Benjamin McCLOSKEY, Evergreen, CO (US); Craig WEINBERG, Denver, CO (US)

(21) Appl. No.: 13/787,486

(22) Filed: Mar. 6, 2013

Related U.S. Application Data
(60) Provisional application No. 61/607,543, filed on Mar. 6, 2012.

(51) Int. Cl. G09B 23/28

(52) U.S. Cl. CPC G09B 23/28
USPC 137/12; 137/624.27; 137/565.13

(57) ABSTRACT

A directional flow valve in a cardiovascular prosthesis test system includes a regurgitant flow passage. Forward flow from a pump through the valve is unrestricted and allowed to pass freely through the directional flow valve. Regurgitant flow is allowed across the directional flow valve to reduce a negative pressure gradient across the prosthetic device. The volume of regurgitant flow is controllable by changing a size of the regurgitant flow pathway.

### CROSS REFERENCE TO RELATED APPLICATIONS

This application claims the benefit of priority pursuant to 35 U.S.C. §119(e) of U.S. provisional application No. 61/607,543 filed 6 Mar. 2012 entitled “Apparatus and method for a regurgitant control directional flow valve for simulating cardiovascular hemodynamics,” which is hereby incorporated herein by reference in its entirety.

### TECHNICAL FIELD

The present disclosure relates to an apparatus and method for the control of regurgitant flow through a directional fluid valve in a cardiovascular prosthesis test system.

### BACKGROUND

During the development and testing of new cardiovascular prostheses, medical device manufacturers create complex flow systems that simulate the physiologic environment the device will be exposed to after implantation. These simulated use test systems typically mimic the geometry, temperature, pressure and flow conditions present in the human body. In order to create clinically relevant pressure and flow waveforms using a mechanically driven positive displacement pulsatile fluid pump, flow conditioning elements are required. These elements are usually comprised of series of compliance and resistance components. However, these elements are limited in their ability to shape and control the pressure waveform present inside the simulated use system and thus the loading of the prosthesis during evaluation.

The information included in this Background section of the specification, including any references cited herein and any description or discussion thereof, is included for technical reference purposes only and is not to be regarded subject matter by which the scope of invention is to be bound.

### SUMMARY

The apparatus and methods described herein provide a way to further shape and control the pressure waveforms, specifically with the ability to eliminate non-clinical pressures within the system when simulating cardiac dynamics.

The present disclosure describes a regurgitant flow valve which may be used in a testing system to simulate physiologic pressure and flow conditions on prosthetic devices during design and performance evaluations. Simulated use testing is accomplished by first deploying the prosthesis in an appropriately sized rigid or flexible housing tube or other appropriate structure. The housing tube and prosthesis being tested is then subjected to physiological appropriate conditions, which may include but is not limited to: pulsatile pressure, pulsatile flow, radial stress/strain, longitudinal stress/strain, bending stress/strain, and physiological temperature.

The regurgitant control directional flow valve is typically implemented on the outflow side of a pulsatile pumping system. The apparatus described here would replace the conventional one way valve typically used on the outflow side of a positive displacement pump. The regurgitant control directional flow valve provides a minimal pressure drop with open flow in the forward direction and a controlled pressure drop and regurgitant flow volume in the reverse direction. This allows for enhanced control of the pressure and flow conditions created inside of the simulated use tester by the pulsatile pumping system. When the simulated use system is set up to test prosthetic cardiac valves, the loading pressure seen by the valve is determined by pressure conditions upstream and downstream of the prosthesis. The regurgitant control directional flow valve allows the system pressure and flow conditions to maintain clinically relevant values by providing a controllable, limited flow path during valve closure.

In one implementation, a cardiovascular prosthesis test system includes a pump, a regurgitant control device on an outflow side of the pump, and a test chamber housing a cardiovascular prosthesis on an outflow side of the regurgitant control device. A method for controlling a pressure gradient across the cardiovascular prosthesis in such a test system may include first passing a forward stream of fluid in a first direction through the regurgitant control device along a first fluid flow pathway across the cardiovascular prosthesis. Next, a regurgitant stream of fluid may be passed in a second direction through the regurgitant control device along a second fluid flow pathway to control a loading differential pressure on the cardiovascular prosthesis.

In another implementation, a regurgitant control device for a cardiovascular prosthesis test system includes a check valve and a secondary flow passage. The check valve may have an open position and a closed position through which a primary flow passage is defined when the check valve is in the open position. The secondary flow passage allows regurgitant flow when the check valve is in the closed position.

In a further implementation a cardiovascular prosthesis test system includes a pump, a regurgitant control device positioned on an outflow side of the pump, and a test chamber configured to house a cardiovascular prosthesis. The regurgitant control device may further include a check valve with an open position and a closed position through which a primary flow passage is defined when the check valve is in the open position. The regurgitant control device may also include a secondary flow passage to allow regurgitant flow when the check valve is in the closed position.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1A depicts a prior art simulated use testing system.

FIG. 1B depicts an exemplary simulated use testing system in accordance with the present disclosure.

FIG. 2 is an isometric view showing a regurgitant-control, directional flow valve that may be used in the system of FIG. 1B.

FIG. 3 is an isometric, exploded view of the regurgitant-control, directional flow valve of FIG. 2.

FIG. 4 is an isometric, partial cross-sectional view of the assembled regurgitant-control, directional flow valve taken along line 4-4 of FIG. 2.

FIG. 5 is a cross-sectional view of the assembled regurgitant-control, directional flow valve of FIG. 2 wherein an exemplary flow path is shown.

FIG. 6 illustrates test data from the simulated use, prior art test system of FIG. 1A, wherein non-clinical, excessive negative ventricle pressure is shown.

FIG. 7 illustrates test data from the simulated use test system of FIG. 1B, wherein excessive negative ventricle pressure has been reduced and/or eliminated in accordance with the apparatus and methods disclosed herein.

FIG. 8 is a flow chart depicting one embodiment of a method for providing regurgitant flow across a valve to reduce or eliminate non-clinical simulated negative ventricle filling pressure in a test system.

### DETAILED DESCRIPTION

A simulated use testing system for testing of various types of cardiovascular prosthetic devices (e.g., cardiac valves, vascular valves, valved conduits, and others) is designed to impart a repeating loading condition for the prosthetic devices during a test run. The system may be variably configured depending upon the device being tested to impart a particular loading profile to repeatedly expose the prosthetic device being tested to desired physiological loading conditions during a test run. The purpose is to simulate typical or specific physiologic loading conditions on a vascular or heart prosthetic valve, or other prosthetic technology, to determine the hydrodynamic performance, deployment characteristics, loading response, efficacy, resiliency, and wear of the devices.

In one implementation, a regurgitant control device may be provided within a cardiovascular prosthesis test system to better simulate physiologic loading conditions and ventricular filling dynamics. The regurgitant control device may include a check valve having an open position and a closed position and a secondary flow passage to allow regurgitant flow when the check valve is in the closed position. The regurgitant control device may further include an adjustment mechanism that regulates a flow volume of a fluid through the secondary flow passage to tune the test conditions.

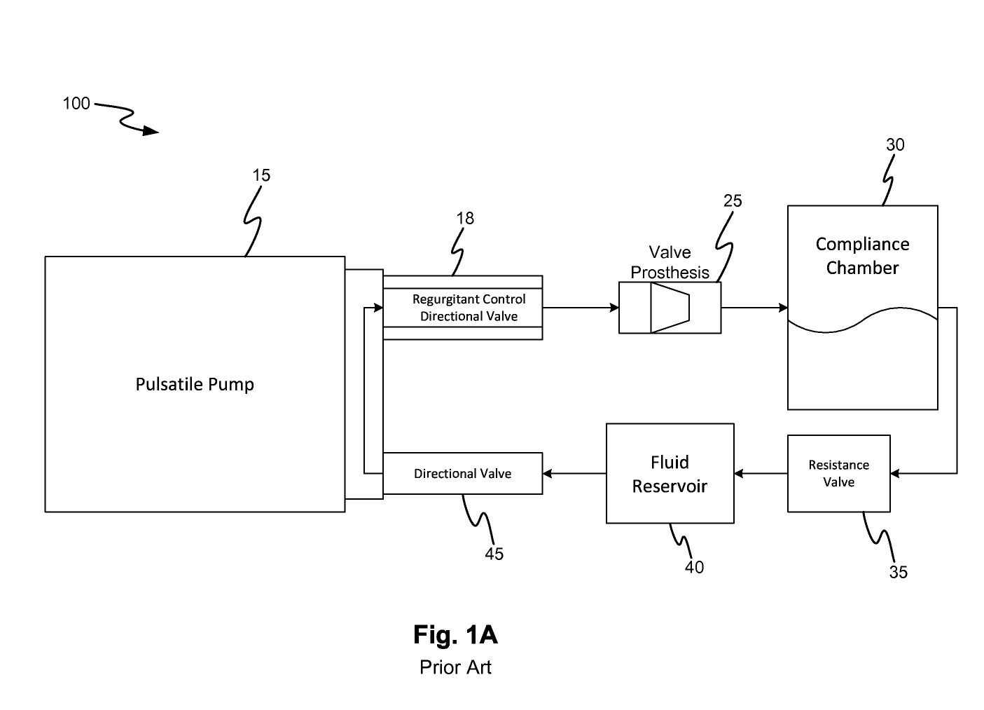

For a discussion of exemplary systems 10 and 100, reference is now made to FIGS. 1A and 1B. FIG. 1A depicts a prior art system 100 having a pulsatile pump 15, an optional check valve 18, a valve prosthesis 25, a compliance chamber 30, a resistance valve 35, a fluid reservoir 40, and a directional valve 45. As shown in FIG. 1B, a test system 10 in accordance with the present disclosure may include similar components as in the prior art system except that the optional check valve is replaced with a regurgitant-control, directional flow valve 20 (hereinafter referred to as “regurgitant flow valve”). In the prior art system, if a check valve is used, there is no backflow. However, if the system does not include a check valve, then too much stress and/or “negative” pressure may be placed on the cardiac valve prosthesis during the simulated ventricle fill cycle, which could cause the leaflets to fail, or the valve prosthesis to fail, or the valve prosthesis to migrate from the deployed position.

The regurgitant flow valve 20 as described herein allows a free flow of fluid in one direction and a controlled flow of fluid in the opposite direction across the regurgitant flow valve 20. That is, the regurgitant flow valve 20 provides a controlled backflow for the system 10. This reduces the amount of stress/pressure on the valve prosthesis 25 and simulates the human vascular system and ventricular filling dynamics more accurately. The regurgitant flow valve 20 acts to partially isolate, in a controlled manner, the pulsatile pump 15 during filling and to provide a more clinically relevant pressure differential across the cardiac valve prosthesis 25. Accordingly, the user receives more accurate performance and characterizing data because the system 10 exhibits a ventricle filling or diastolic pressure as is typically found in the human vascular system.

In other implementations, the components of the system 10 may be in a different order from that shown in FIG. 1B. For example, the compliance chamber 30 may be located between the regurgitant valve 20 and the valve prosthesis 25, or in both locations. The arrows represent the flow of the working fluid through the system.

As can be understood from FIG. 1B, performance testing is accomplished by first deploying the prosthetic device (e.g., a cardiac valve prosthesis) in an appropriately sized sample holder (e.g., a rigid or flexible tube, canister, or housing) or other appropriate structure for holding the prosthetic device being tested. The sample holder is then placed into the test system that together forms a closed, cyclic pathway for a working fluid. The working fluid may be water, saline, a saline/glycerin solution, a glycerin/water solution, or a blood analog or similar substitute. The working fluid may be selected to simulate one or more attributes of human blood, such as density, viscosity or temperature. For example, in certain exemplary implementations, physiological saline, which does not simulate the viscosity of blood, but simulates density, may be used. In other exemplary implementations, a saline/glycerin solution may be employed to simulate blood density and viscosity. The sample holder and cardiovascular valve being tested are then subjected to physiological appropriate conditions which may include one or more of the following: pressure, temperature, flow rate, and cycle times.

In one exemplary implementation, where the system 10 simulates the heart and the prosthetic valve is an aortic valve replacement, the pulsatile pump acts as a left ventricle. The resistance valve 35 acts like peripheral vasculature/capillaries and the fluid reservoir 40 acts like a venous circuit (i.e., a low pressure return). As used herein, “compliance” refers to the ability of the compliance chamber 30 to absorb some of the pressure placed upon the fluid in the system 10 and further to control recoil toward the original volume dimensions upon removal of the compressive force. The compliance chamber 30 assists in minimizing the effects of large and quickly changing pressure gradients across test samples (e.g., a cardiac valve prosthesis 25) placed within the test system 10 and provides a capacitive storage of energy and fluid volume presented during systolic ejection of the pulsatile pump 15. In some exemplary implementations, the compliance chamber 30 may merely contain air or another gas. The air or other gas may be in direct contact with the working fluid in the system or a membrane may be provided within the compliance chamber 30 to separate the air or gas from the working fluid. In other embodiments, the compliance chamber 30 may house a porous material or an elastomeric material.

Testing and test conditions are controlled by a control computer (not shown) that permits both input of test conditions and monitors feedback of the test conditions during a testing run. The computer system control may be either an open loop control that requires user intervention in the event a condition falls outside pre-set condition parameters or a closed loop control system in which the computer monitors and actively controls testing parameters to ensure that the test conditions remain within the pre-set condition parameters.

The system 10 is capable of simulating physiologic conditions on prosthetic devices 25 at physiological “real-time” or slightly accelerated “quasi real-time” rates. The system 10 may also be configured to create either sinusoidal or non-sinusoidal pressure and/or flow waveforms across the prosthetic device 25. Pressure waveforms may also be applied that produce a pre-defined pressure gradient over time to a prosthetic device 25 being tested.

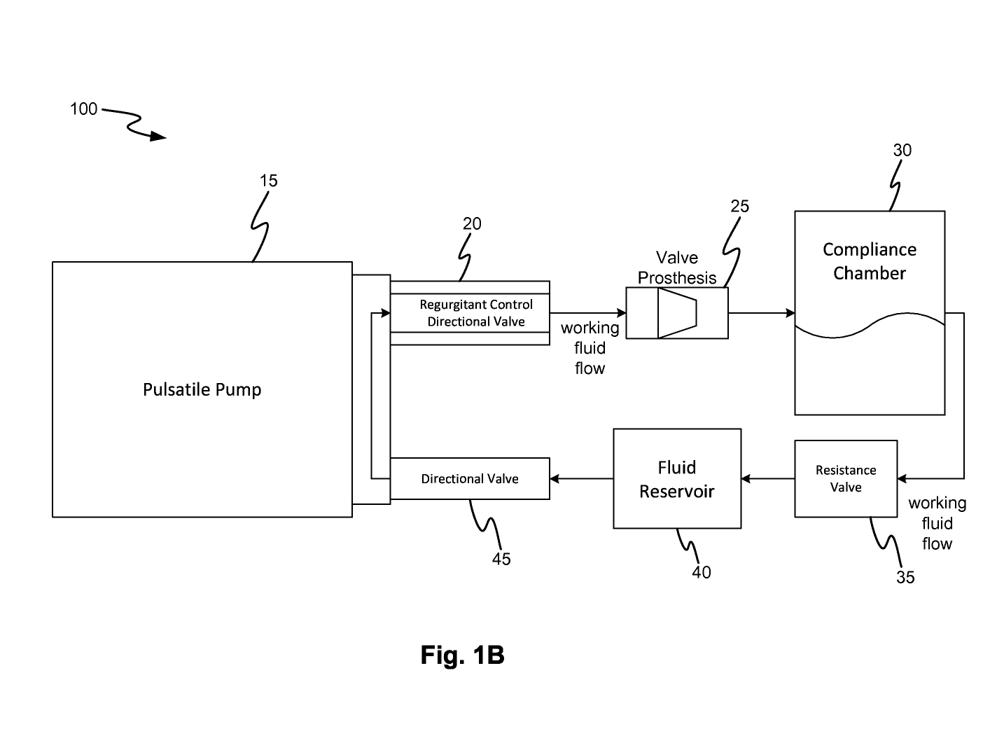

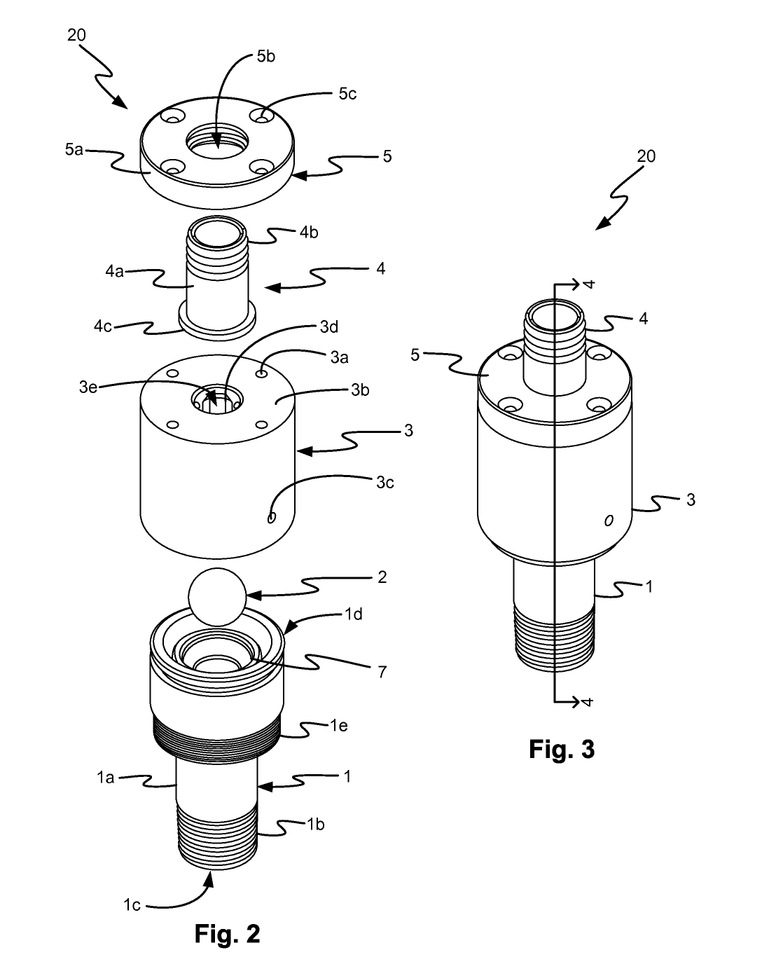

For a discussion of one exemplary implementation of the regurgitant flow valve 20, reference is now made to FIGS. 2-5, which depict isometric and cross sectional views of the regurgitant flow valve 20 and the fluid flow therethrough. As shown in FIGS. 2-4, the regurgitant flow valve 20 includes a backflow valve seat 1, a valve ball 2, a regurgitant control mechanism 3, a rotational fluid outlet 4, and an outlet clamp 5. As can be seen in FIGS. 3-5, the backflow valve seat 1 includes an elongated tubular body 1a with threading or barbs 1b at a first end 1c for connection to pipe or tubing in the cyclic flow path of the system 10. The elongated tubular body 1a increases in diameter towards a second end 1d and includes fine threading 1e about an outer circumference of the body 1a. The elongated tubular body 1a is configured to receive a backflow ball seat 7. The backflow ball seat 7 may be formed as a hollow cylindrical body with a tapered inner wall at a first end for seating the valve ball 2 and a disc-shaped flange 7a extending radially outward at a second end. The flange 7a defines one or more apertures 7b configured for providing the regurgitant fluid flow through the regurgitant flow valve 20.

As shown in FIGS. 3-5 and others, the control mechanism 3 may be formed as a hollow, generally cylindrical body with an open first end and a capped second end 3b with fastener apertures 3a (e.g., threaded apertures) and a fluid flow aperture 3e. The inner wall of the cylindrical body adjacent the open first end may be formed with fine threading 3f. A flow-through valve seat 3d may be positioned with a cavity formed in the cylindrical body of the control mechanism 3. During forward fluid flow, the flow-through valve seat 3d traps the valve ball 2 while allowing fluid to flow freely around the valve ball 2. The control mechanism 3 fits around the second end 1d of the backflow valve seat 1 and the threading 3f of the control mechanism 3 interfaces with the threading 1e of the backflow valve seat 1 such that the control mechanism 3 and the backflow valve seat 1 are fastened together. The backflow valve seat 1 may define an annular groove 1f in an outer surface thereof to receive a sealing member 1f, e.g., and O-ring 1f, to provide a fluid-tight seal between the control mechanism 3 and the backflow valve seat 1. In alternative embodiments, the control mechanism 3 may house the sealing member 1f or another form of seal between the two components may be provided.

In some implementations, the control mechanism 3 may also include and at least one aperture 3c through an outer surface of the cylindrical body to the inner cavity, which may accept a set screw to prevent rotation of the control mechanism 3 with respect to the after the regurgitant flow valve 20 has been set at the appropriate condition. The control mechanism 3 is configured to engage the backflow valve seat 1 and retain the valve ball 2 between the backflow ball seat 7 and the flow-through valve seat 3d.

As shown in FIGS. 3-5, the rotational fluid outlet 4 of this exemplary embodiment includes a tubular body 4a with threading or barbs 4b at one end for connection to pipe or tubing in the cyclic flow path of the system 10 and a circular flange 4c extending radially from and around an inlet opening in the opposite end.

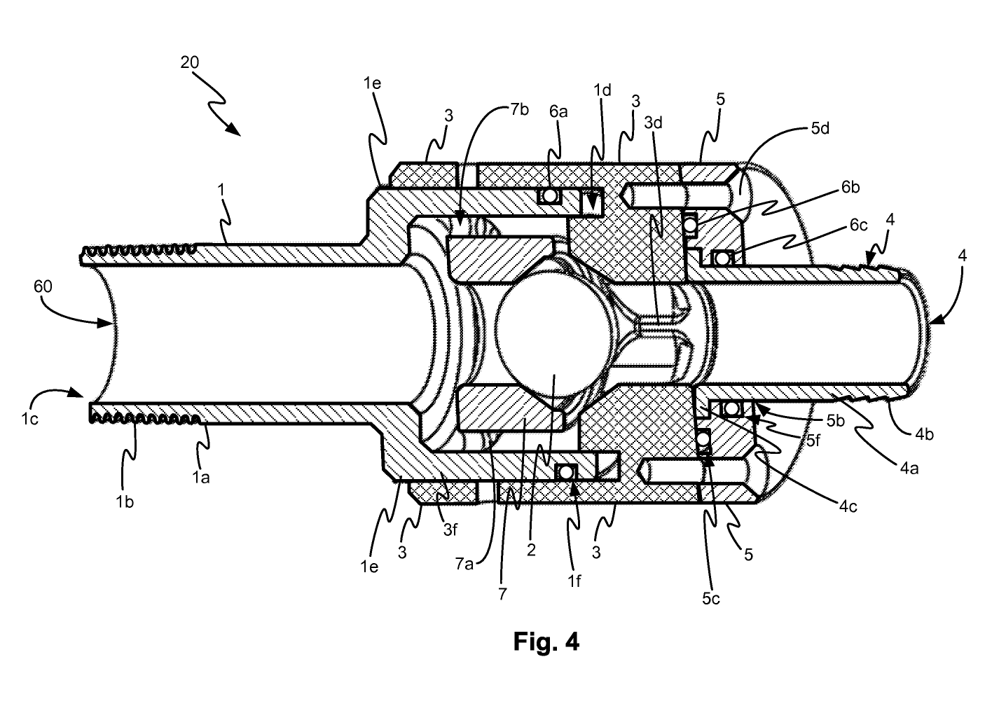

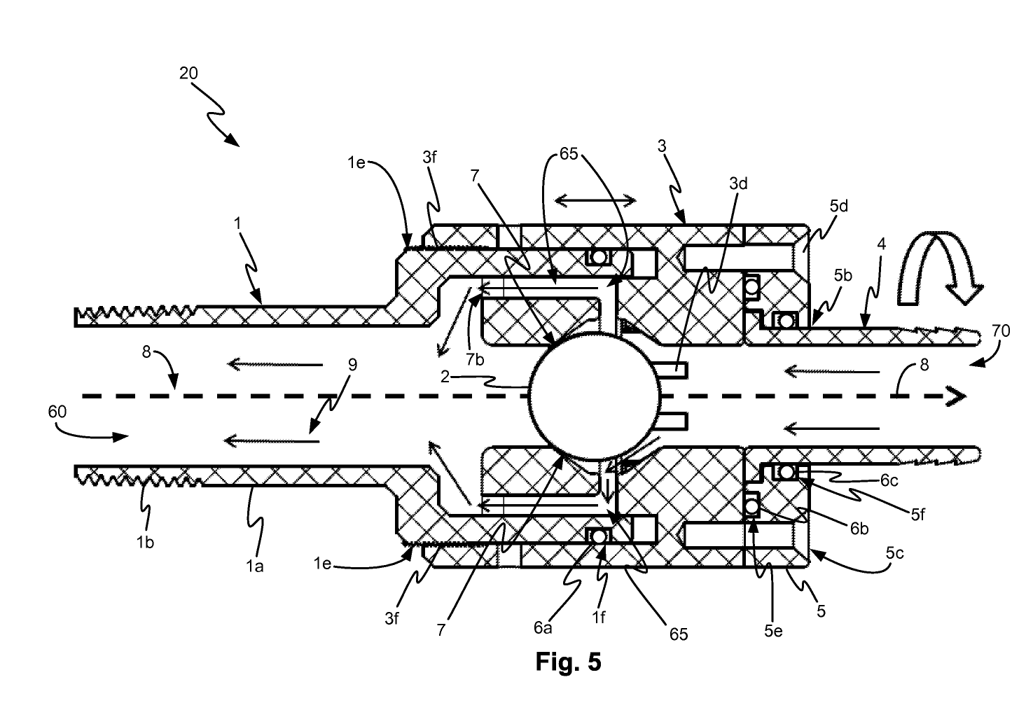

The outlet clamp 5 is formed as a disk-shaped body 5a defining fastener apertures 5c and a center aperture 5b that fits around the tubular body 4a of the rotational fluid outlet 4. The center aperture 5b may be formed to increase in diameter adjacent a bottom face of the outlet clamp 5 in order to receive the circular flange 4c of the rotational fluid outlet 4. The fastener apertures 5c are configured to receive a respective fastening devices 5d, such as pins or screws (see FIG. 4). The outlet clamp 5 may further define a first annular channel 5e on the bottom face thereof and a second annular channel 5f on an inner wall defining the center aperture 5b. Each of the first and second annular channels 5e, 5f receives respective sealing members 6b, 6c (e.g., O-rings) for providing a fluid tight seal between the outlet clamp 5 and the control mechanism 3 and the rotational fluid outlet, respectively, as shown in FIGS. 4 and 5.

As seen in FIGS. 3-5, the outlet clamp 5 sandwiches or otherwise maintains the rotational fluid outlet 4 between the outlet clamp 5 and the regurgitant control mechanism 3. The fastening devices 5d extend through the fastener apertures 5c in the outlet clamp 5 and engage the fastener apertures 3a in the regurgitant control mechanism 3. Sufficient clearance may be provided between the in interface of the rotational fluid outlet 4 and the outlet claim 5 such that the rotational fluid outlet 4 can freely rotate within the outlet clamp 5 while being maintained between the outlet clamp 5 and the regurgitant control mechanism 3. The sealing members 6b, 6c provide a fluid-tight seal against the rotational fluid outlet 4 and the regurgitant control mechanism 3 even while the rotational fluid outlet 4 is rotated.

The primary forward fluid flow path 8 runs from the entrance port 60 of the valve seat 1 around the valve ball 2 and through a concentric bypass path 65, through the regurgitant control mechanism 3 and the flow-through valve 3d therein, and out the rotational fluid outlet 4 at an outlet 70. The secondary regurgitant fluid flow pathway 9 runs from the outlet 70 through the rotational fluid outlet 4, through the flow-through valve 3d in the regurgitant control mechanism 3, through the secondary or concentric bypass channels 65 in the space between backflow ball seat 7 and the valve seat 1, through the apertures 7b in the flange 7a of the backflow ball seat 7, through the valve seat 1, ant out the inlet 60.

As can be understood from FIG. 5, in a forward flow direction in response to a discharge or pulse portion of the cycle from the pump 15, the valve ball 2 is forced against the flow-through valve seat 3d within the control mechanism 3. Fluid flows around the valve ball 2 in a primary flow path 8 through the flow-through valve seat 3d and also through a concentric bypass flow path 65 around the around the backflow ball seat 7 through the apertures 7b in the flange 7a thereof. Thus, in this exemplary embodiment, the concentric bypass flow path 65 is also part of the primary flow path 8 between the inlet 60 and the outlet 70 of the regurgitant flow valve 20 and may be included in the primary flow volume calculation when designing the system 10. However, in an alternate embodiment, the apertures 7b in the flange 7a of the backflow ball seat 7 may be provided with check valves (e.g., reed valves) that prevent forward flow therethrough and thus prevent the concentric bypass flow path 65 from being part of the primary flow path 8.

When the pump 15 cycles into the suction phase, a negative pressure is created across the regurgitant flow valve 20. The valve ball 2 is thus pulled against the backflow ball seat 7 and seals the primary flow path 62 through the center of the backflow ball seat 7. However, the bypass flow path 65 around the backflow ball seat 7 remains open and thus provides a secondary flow path allowing regurgitant flow in a reverse flow direction 9 through the regurgitant flow valve 20.

As noted, the valve seat 1 is connected or coupled via a fine thread 1b to the threaded wall 3f of the regurgitant control mechanism 3. The regurgitant control mechanism 3 is adjustable relative to the valve seat 1 to control the fluid restriction to the concentric bypass flow path 65 between the backflow ball seat 7 and the valve seat 1. The threading 3f on the regurgitant control mechanism 3 may engage more threads 1b on the valve seat 1 to decrease the gap or diameter of the entrance to the bypass flow path 65 and alternatively, the regurgitant control mechanism 3 may engage fewer threads 1b on the valve seat 1 to increase the gap or diameter of the entrance to the bypass flow path 65. Thus, the regurgitatnt flow through the regurgitant flow valve 20 may be increased or decreased by changing the gap or diameter of the entrance to the bypass flow paths 65.

Such adjustment allows a regurgitant flow to range from effectively 0 ml/min if the entrance to the bypass flow path 65 is completely closed, up to a maximum which will be dependent upon the pulsatile pump 15 operating condition and the remaining components 30, 35, 40, 45 operating together as a test system. In some exemplary systems, a maximum regurgitant flow may be on the order of 2 L/min. The system 10 thereby provides for a regurgitant flow that can be adjusted to more accurately simulate the human cardiovascular system in which the prosthetic device will be used. Thus, a user may gather actual clinical data from a particular patient and model that patient in a test system. In this way, the regurgitant valve 20 may be used to adjust flow to simulate clinical performance.

The exemplary regurgitant control directional flow valve 20 provides one device that may be used in a simulated use testing system to control the pressure gradient across the prosthetic valve by, for example, adjusting the backflow through the system or the regurgitant flow valve 20. Other devices or system additions may also be used to provide for backflow, whether adjustable or not, and thereby adjust or control the pressure gradient across the prosthetic device. Such devices or additions may include, but are not limited to, a parallel back channel, a porous valve ball (or other fluid interrupting structure) in a check valve or a valve ball (or other fluid interrupting structure) with one or more bore or weep holes provided therethrough to allow for regurgitant flow. Adjustment of the regurgitant flow volume in a back channel may be provided with a flow regulator along the back channel, for example, a needle valve. Inlets and outlets to the backchannel may be provided with check valves (e.g., reed valves) to avoid undesired backflow during a positive pressure flow cycle. Adjustment of the regurgitant flow in an embodiment using a porous valve ball or a valve ball with a weep hole can be provided by exchanging between valve balls of different porosity or between valve balls with weep holes of differing diameter.

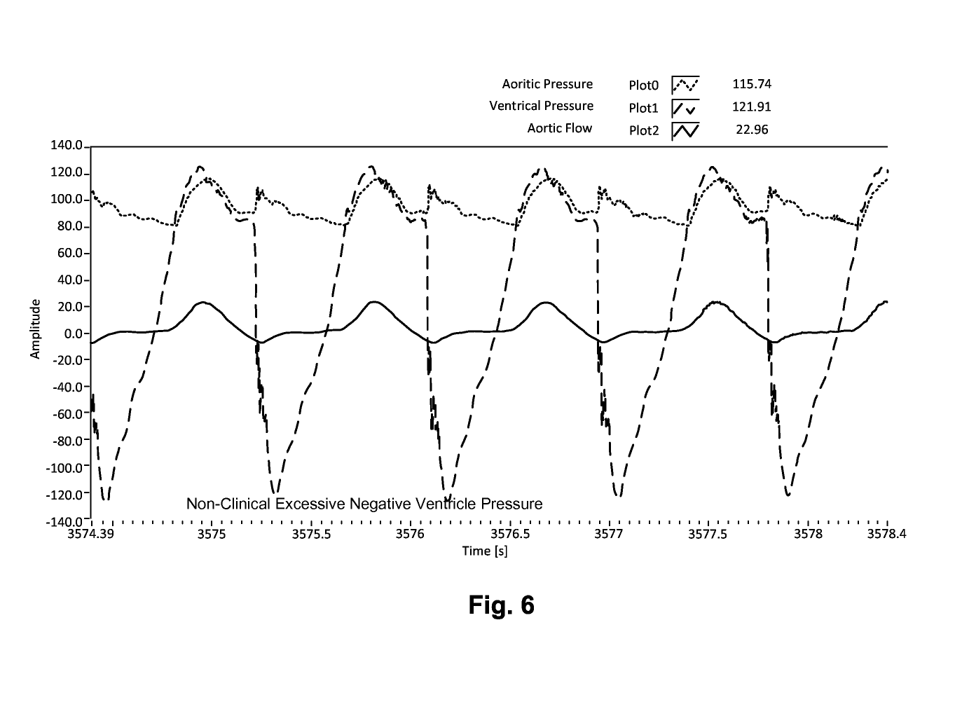

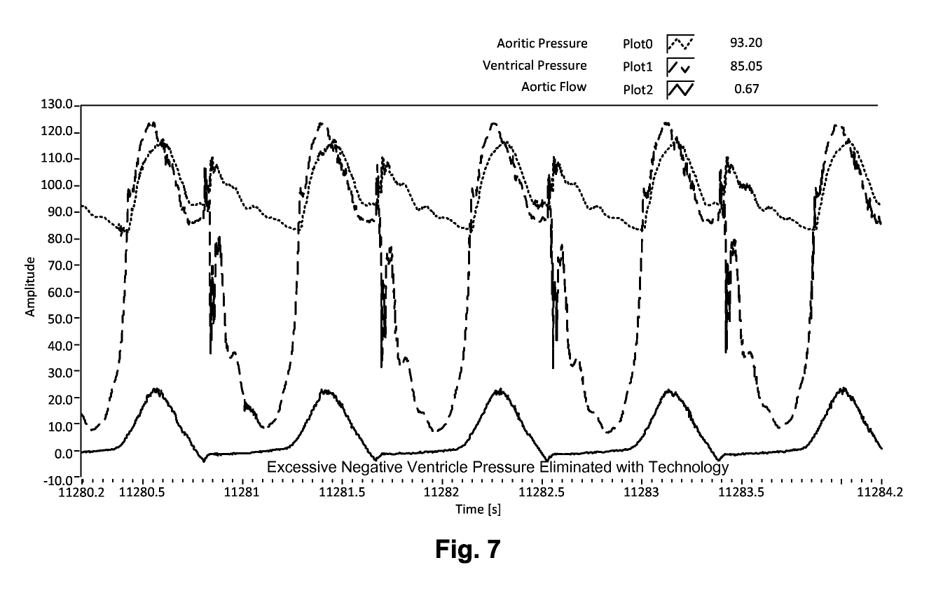

FIGS. 6 and 7 illustrate the effect of the regurgitant flow valve 20 in a system. A system similar to one shown in FIGS. 1A and 1B was established. The data shown in FIG. 6 is from a prior art system using no check valve, as shown in FIG. 1A. As shown in FIG. 6, the ventricle filling pressure is excessive and is not representative of ventricle filling pressure in a human system. The data shown in FIG. 7 is from a system using the regurgitant flow valve 20, as shown in FIG. 1B. As shown in FIG. 7, the ventricle filling pressure is not excessive and generally representative of ventricle filling pressures that may occur in a human system. Thus, the regurgitant flow valve lessens, reduces or eliminates, as appropriate, the negative pressure during filling of the pulsatile pump when there is no check valve in place. Further, in contrast to systems with standard check valves, the regurgitatnt flow valve provides a more clinically appropriate differential pressure across the cardiac prosthesis, which reduces the peak differential pressure on the leaflets of the prosthetic valve, thereby reducing the chance that the leaflets will artificially fail or the prosthetic valve will dislodge from the test system.

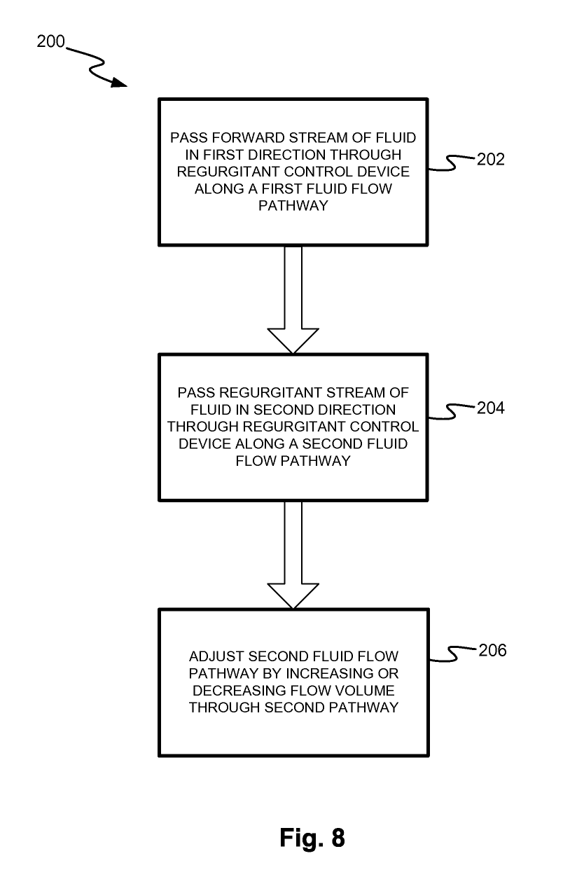

An exemplary method for controlling a pressure gradient across a cardiovascular prosthesis in a test system is presented in FIG. 8 and with continued reference to FIG. 5. FIG. 8 is a flow diagram of one implementation of a method 200 for controlling a pressure gradient across a test article in a cardiovascular prosthesis test system. As explained elsewhere herein, the test system may include a pump, such as a pulsatile pump, a regurgitant control device on the outflow side of the pump, and a test chamber housing a cardiovascular prosthesis on an outflow side of the regurgitant control device. As shown in Block 202, the method includes passing a forward stream of fluid in a first direction through the regurgitant control device along a first fluid flow pathway across the cardiovascular prosthesis. In Block 204, the method further includes passing a regurgitant stream of fluid in a second direction through the regurgitant control device along a second fluid flow pathway to control a loading differential pressure on the cardiovascular prosthesis. This reverse fluid flow aids in controlling the pressure gradient of the system thereby providing a more clinically relevant pressure differential across the cardiovascular prosthesis and producing more accurate testing conditions and results. As can be understood from FIG. 5, the first fluid flow path may be a free flow fluid path and the second fluid flow path may be a restricted fluid flow path. As shown in Block 206, the method may further include adjusting the second fluid flow pathway by increasing or decreasing the flow volume through the second pathway. In the example of FIG. 5, this is achieved by adjusting the position of the regurgitant control mechanism 3 with respect to the valve seat 1 by screwing these components further apart or closer together to enlarge or narrow the opening from the primary fluid flow path

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as claimed below. Although various embodiments of the invention as claimed have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for controlling a pressure gradient across a cardiovascular prosthesis in a cardiovascular prosthesis test system including a pump, a regurgitant control device on an outflow side of the pump, and a test chamber housing a cardiovascular prosthesis on an outflow side of the regurgitant control device, the method comprising
passing a forward stream of fluid in a first direction through the regurgitant control device along a first fluid flow pathway across the cardiovascular prosthesis; and
passing a regurgitant stream of fluid in a second direction through the regurgitant control device along a second fluid flow pathway to control a loading differential pressure on the cardiovascular prosthesis.

2. The method of claim 1 further comprising adjusting a flow volume through the second fluid flow pathway.

3. The method of claim 2, wherein the adjusting operation further comprises adjusting a size of the second fluid flow pathway.

4. The method of claim 1, wherein the second fluid flow pathway defines at least a portion of the first fluid flow pathway.

5. The method of claim 1, wherein the first fluid flow pathway defines at least a portion of the second fluid flow pathway.

6. The method of claim 1, wherein secondary flow passage is separate from and in parallel with the primary flow passage.

7. A regurgitant control device for a cardiovascular prosthesis test system, the device comprising
a check valve having an open position and a closed position through which a primary flow passage is defined when the check valve is in the open position; and
a secondary flow passage to allow regurgitant flow when the check valve is in the closed position.

8. The regurgitant control device of claim 7 further comprising an adjustment mechanism that regulates a flow volume of a fluid through the secondary flow passage.

9. The system of claim 7, wherein the primary flow passage forms at least a portion of the secondary flow passage.

10. The system of claim 9, wherein a seal structure in the check valve is porous and the porous seal structure forms at least a portion of the secondary flow passage.

11. The system of claim 9, wherein a seal structure in the check valve defines a through-hole that forms at least a portion of the secondary flow passage.

12. The system of claim 7, wherein the secondary flow passage is separate from and in parallel with the primary flow passage.

13. A cardiovascular prosthesis test system comprising
a pump;
a regurgitant control device positioned on an outflow side of the pump and further comprising
a check valve having an open position and a closed position through which a primary flow passage is defined when the check valve is in the open position; and
a secondary flow passage to allow regurgitant flow when the check valve is in the closed position; and
a test chamber configured to house a cardiovascular prosthesis.

14. The system of claim 13 wherein the test chamber is positioned on an outflow side of the regurgitant control device.

15. The system of claim 13 with the test chamber is positioned in parallel with the regurgitant control device.

16. The system of claim 13, wherein the reguritant control device is adjustable to control a flow volume of the regurgitant flow through the secondary flow passage.

17. The system of claim 13, wherein the primary flow passage forms at least a portion of the secondary flow passage.

18. The system of claim 17, wherein a seal structure in the check valve is porous and the porous seal structure forms at least a portion of the secondary flow passage.

19. The system of claim 17, wherein a seal structure in the check valve defines a through-hole that forms at least a portion of the secondary flow passage.

20. The system of claim 13, wherein the secondary flow passage is separate from and in parallel with the primary flow passage.
